(19) United States
(12) Patent Application Publication
(10) Pub. No.: US 2011/0077058 A1
(43) Pub. Date: Mar. 31, 2011

(54) OFFLINE CHARGING IN IMS NETWORKS FOR SESSIONS HANDED OVER BETWEEN DIFFERENT OPERATOR NETWORKS

(76) Inventors: Yigang Cai, Naperville, IL (US); Ranjan Sharma, New Albany, OH (US); Shengqiang Wang, Cary, NC (US)

(21) Appl. No.: 12/570,257

(22) Filed: Sep. 30, 2009

(51) Int. Cl. H04B 1/38

(52) U.S. Cl. 455/573

(57) ABSTRACT

IMS networks and methods are disclosed for providing offline charging for a session of an IMS device that is seamlessly handed over between a home IMS network and a visited IMS network that are different operator networks. A roaming charging identifier (RCID) is assigned to the session in the home IMS network that is global to a dialog of the session over the home IMS network and to a dialog of the session over the visited IMS network. Network elements in the home IMS network insert the RCID in offline charging requests that are sent to an offline charging system. The offline charging system generates CDRs for the session that also include the RCID. The offline charging system can then aggregate and correlate the CDRs for the session based on the RCID.

### BACKGROUND

1. Field of the Invention

The invention is related to the field of communication networks and, in particular, to providing for offline charging in IMS networks for sessions that are handed over between different operator networks.

2. Statement of the Problem

One type of communication network gaining popularity is an IP Multimedia Subsystem (IMS) network. As set forth in the 3^{rd} Generation Partnership Project (3GPP), the IMS provides a common core network having a network architecture that allows for various types of access networks. The access network between a communication device and the IMS network may be a cellular network (e.g., CDMA or GSM), a WLAN (e.g., WiFi or WiMAX), an Ethernet network, or another type of wireless or wireline access network. The IMS architecture is initially defined by the 3GPP to provide multimedia services to communication devices over an Internet Protocol (IP) network, as IP networks have become the most cost savings bearer network to transmit video, voice, and data. Service providers are accepting this architecture in next generation network evolution.

For a typical session (or call) within an IMS network, user equipment (UE) of an IMS end user initiates the session through an access network, such as a CDMA network, a GSM network, an IP network, a WiFi network, a WiMAX network, etc, by transmitting the appropriate signaling messages (i.e., SIP messages). The access network then routes the signaling messages to the IMS network. A serving-call session control function (S-CSCF) in the IMS network receives the signaling messages and attempts to establish the session in the appropriate manner. When the session is established, the S-CSCF may also contact one or more application servers (AS) in the IMS network to provide services for the session, such as voicemail, call forwarding, etc.

To provide offline charging for the session, each of the IMS network elements (e.g., S-CSCF and AS) handling the session generates offline charging requests typically in Diameter Rf protocol. For instance, a network element transmits a “start” charging request, such as a Diameter Accounting Request (ACR[start]), to a Charging Data Function (CDF) in the IMS network at an initial triggering event. Periodically during the session, the network element transmits “interim” charging requests, such as a Diameter ACR[interim], to the CDF. At an ending triggering event, the network element transmits a “stop” charging request, such as a Diameter ACR[stop], to the CDF. Each of the charging messages includes an IMS Charging Identifier (ICID) that is assigned to the session.

The CDF then processes the offline charging requests received from the network elements that are serving the session to generate Charging Data Records (CDR) for the session. The CDF transmits the CDRs to a Charging Gateway Function (CGF) that correlates the CDRs that have been generated for the session based on the ICID. The CGF then transmits a consolidated CDR to a billing system. The billing system may resolve charging for the session based on the consolidated CDR.

An IMS end user may roam out of his/her home network and into a visited network. When this occurs, the session may be seamlessly handed over from the home network to the visited network so that the session may continue without interruption. One network element that assists in the seamless handover of sessions from one network to another is referred to as a Voice Call Continuity (VCC) application server.

One problem encountered by service providers is that offline charging is difficult when a session is handed over between different operator networks when the IMS end user is roaming. When an IMS end user roams from a first operator network (i.e, the home network) to a second operator network (i.e., the visited network) and the session is handed over (i.e., through the VCC application server), the first operator network will close the CDR for the session and the second operator network will open a new CDR for the session even though the session is continued through a seamless handover. Thus, a single session will be billed as two different sessions when handover occurs. Billing in this manner is especially problematic especially when a stepped rating is used for the session.

### SUMMARY

Embodiments described herein provide for seamless offline charging for a session that has been handed over between different operator networks. When a session is initiated and the session is allowed to be handed over between a home IMS network and a visited IMS network (i.e., different operator networks), a roaming charging identifier (RCID) is assigned for the session. The RCID is distributed to network elements in the home IMS network for offline charging. When charging is triggered in the network element, the network element inserts the RCID in offline charging requests to the offline charging system. The offline charging system (e.g., CDF/CGF) may then generate a CDR for the session that includes the RCID. If multiple CDRs are generated for the session, then the offline charging system is able to aggregate and correlate the CDRs based on the RCID. As a result, the session is charged as a single session even though it was handed over between different operator networks.

One embodiment comprises a network element in a home IMS network that is operable to receive a session initiation request (e.g., a SIP INVITE) for a session that is allowed to be handed over between a home IMS network and a visited IMS network. The home IMS network and the visited IMS network are different operator networks. The network element is further operable to assign a roaming charging identifier (RCID) for the session that is global to a dialog of the session over the home IMS network and to a dialog of the session over the visited IMS network, if the session is handed over between the home IMS network and the visited IMS network. The network element is further operable to distribute the roaming charging identifier to other network elements in the home IMS network for offline charging.

In another embodiment, the network element is further operable to identify a triggering event during the session, to identify the roaming charging identifier assigned to the session, to generate an offline charging request and insert the roaming charging identifier in the offline charging request, and to transmit the offline charging request to an offline charging system.

Another embodiment comprises a system for providing offline charging. The system includes a charging data function operable to receive offline charging requests from one or more network elements in the home IMS network for the session. The charging data function is further operable to open charging data records (CDRs) for the session based on the offline charging requests, and to insert the roaming charging identifier in the CDRs. The charging data function is further operable to receive additional offline charging requests from the network elements in the home IMS network for the session, and to close the CDRs for the session based on the additional offline charging requests.

In another embodiment, the system includes a charging gateway function operable to identify the CDRs for an individual network element that include the roaming charging identifier assigned to the session, and to aggregate the CDRs for the individual network element based on the roaming charging identifier into an aggregated charging data record. The charging gateway function is further operable to identify the CDRs that include the roaming charging identifier assigned to the session, and to correlate the CDRs for the session based on the roaming charging identifier into a consolidated CDR. The charging gateway function is further operable to transmit the consolidated CDR to a billing system. Because the charging gateway function is able to provide a single consolidated CDR to the billing system for the session, the billing system is able to bill the session as a single session even though it was handed over between different operator networks.

The invention may include other exemplary embodiments described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 is a flow chart illustrating a method of assigning a Roaming Charging Identifier (RCID) for a handover session in an exemplary embodiment.

FIG. 3 is a flow chart illustrating a method of sending offline charging requests for a handover session to an offline charging system in an exemplary embodiment.

FIG. 4 is a flow chart illustrating a method of processing offline charging requests in a charging data function to generate CDRs in an exemplary embodiment.

FIG. 5 is a flow chart illustrating a method of aggregating CDRs in a charging gateway function in an exemplary embodiment.

FIG. 6 is a flow chart illustrating a method of correlating CDRs in a charging gateway function in an exemplary embodiment.

FIGS. 7-12 are message diagrams illustrating a session handed over between different operator networks in an exemplary embodiment.

FIG. 13 illustrates CDRs sent from a charging data function to a charging gateway function in an exemplary embodiment.

FIG. 14 illustrates aggregation of CDRs for an S-CSCF in an exemplary embodiment.

FIG. 15 illustrates correlation of CDRs for session in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

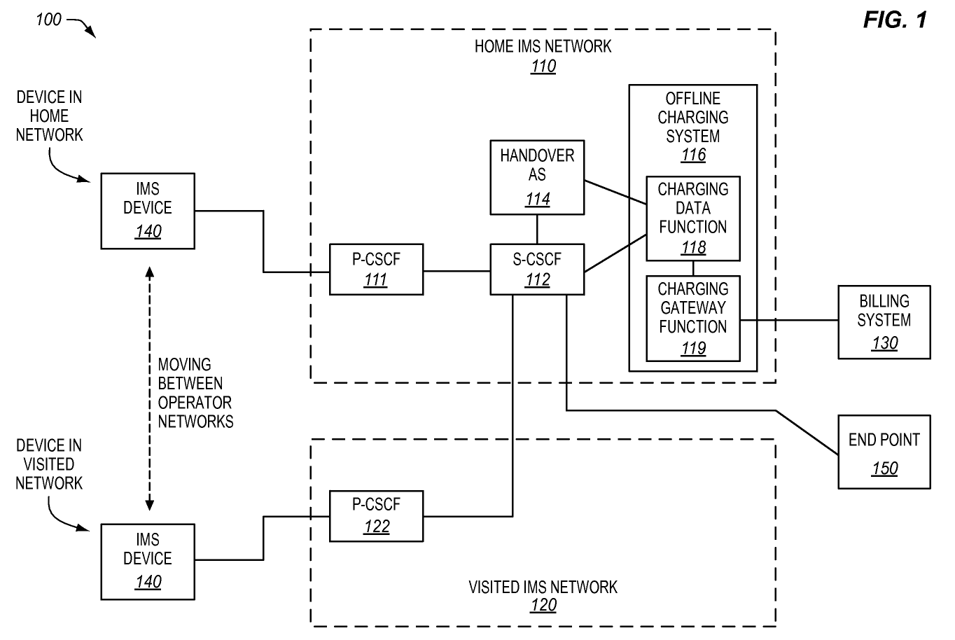

FIG. 1 illustrates a communication network 100 in an exemplary embodiment of the invention. Communication network 100 includes a home IMS network 110, a visited IMS network 120, and billing system 130. Home IMS network 110 includes a proxy call session control function (P-CSCF) 111, a serving-call session control function (S-CSCF) 112, a handover application server 114 (also referred to as a Voice Call Continuity (VCC) application server), and an offline charging system 116. Home IMS network 110 may include other network elements that are not shown for the sake of brevity, such as a Breakout Gateway Control Function (BGCF), a Media Gateway Control Function (MGCF), etc. Visited IMS network 120 includes a P-CSCF 122. Like home IMS network 110, visited IMS network 120 may include other network elements that are not shown for the sake of brevity. Billing system 130 comprises any system, server, or function adapted to process charging data records (CDRs) to generate or resolve a bill for a session in home IMS network 110.

Each of home IMS network 110 and visited IMS network 120 may be connected to an access network (not shown). IMS networks allows for a variety of types of access to an IMS device (also referred to as user equipment (UE)). For instance, an IMS access network may comprise a cellular network, such as a CDMA network or a GSM network. An IMS access network may comprise a wireless LAN, such as a WiFi network or WiMAX network. Home IMS network 110 and visited IMS network 120 may have similar access networks or may have different access networks in order to communicate with IMS device 140.

Within home IMS network 110, P-CSCF 111 and S-CSCF 112 comprise any systems, servers, or functions operable to establish, maintain, or tear down a session in home IMS network 110. Handover application server (AS) 114 comprises any system, server, or function adapted to provide a handover service for a session of IMS device 140. Handover application server 114 may comprise a Voice Call Continuity (VCC) application server that is operable to provide voice call continuity when an IMS user is moving between a Circuit Switched (CS) domain and an IMS domain. The handover application server or VCC application server may include a mobile management AS option (not shown) and a network domain selection function (not shown) to perform handover between different wireless domains. The mobile management AS is where the IMS core network emulates an MSC to a circuit-switched network for subscriber access on IMS network. The network domain selection function determines call delivery routing. The service logic of the network domain selection function routes the session to the appropriate domain (IMS or circuit-switched) based on the current state of registration within the domains and operator and subscriber preferences. Handover application server 114 processes signaling messages for the session to provide a handover from home IMS network 110 to visited IMS network 120 (or vice-versa) without interruption of the session. Offline charging system 116 comprises any system, server, or function operable to receive offline charging requests from network elements that are serving the session, such as P-CSCF 111, S-CSCF 112, and handover application server 114, and to generate charging data records (CDR) for the session. Offline charging system 116 is illustrated as including a charging data function 118 and a charging gateway function 119. In the embodiments provided herein, home IMS network 110 and visited IMS network 120 represent different operator networks. An operator network refers to an IMS core network owned, controlled, managed, and/or operated by a communication service provider. An example of one service provider may be Verizon Wireless that manages one operator network to provide mobile services, and another service provider may be AT&T that manages another operator network. In the embodiments below, one may assume that home IMS network 110 is controlled by service provider A while visited IMS network 120 is controlled by service provider B.

The embodiments described herein provide call continuity when a session (or call) is handed over from one operator network to a different operator network, and provides seamless offline charging capability for the session that is handed over. Presently, when an IMS device roams from a first operator network (i.e., home IMS network 110) to a second operator network (i.e., visited IMS network 120), the first operator network will close the CDR for the session and the second operator network will open a new CDR for the session even though the session is continued through a seamless handover. Thus, a single session will be charged as two different sessions when handover occurs. Through the seamless offline charging described herein, sessions that are handed over between different operator networks will not be charged as two different session. A roaming charging identifier (RCID) is assigned for the session, and the RCID is used to aggregate and correlate multiple CDRs for a handover session in offline charging system 116. Thus, the handover session may be charged as a single session based on the RCID.

Assume that IMS device 140 initially registers with home IMS network 110 and initiates a session with an end point 150 by transmitting a session initiation message (e.g., a SIP INVITE) to home IMS network 110. S-CSCF 112 receives the session initiation message for the session, and processes initial filter criteria (iFC) for IMS device 140 to identify that IMS device 140 is allowed handover between different operator networks. The iFC provides an address for handover application server 114. Thus, S-CSCF 112 transmits the appropriate signaling message to handover application server 114 to allow for seamless handover during the session.

When the session is established through home IMS network 110, a network element in home IMS network 110 will assign a first IMS Charging Identifier (ICID) to the session. The ICID is related to one or more dialogs for the session established through home IMS network 110. As an example of assigning an ICID, if IMS device 140 initiates the session in home IMS network 110 with a session initiation message (e.g., SIP INVITE), then P-CSCF 111 in home IMS network 110 may assign the ICID that is unique to one or more dialogs over home IMS network 110.

P-CSCF 111, S-CSCF 112, and handover application server 114 have Charging Trigger Functions (CTF) defined to provide offline charging for the session. When a CTF in a network element (e.g., P-CSCF 111, S-CSCF 112, or handover application server 114) identifies a triggering event, the network element generates an offline charging request for the session. The offline charging request may be a start, interim, or stop message. As an example, the offline charging request may comprise an Accounting Request (ACR) [start, interim, stop] as defined in Diameter Rf protocol. The network element inserts the ICID in the offline charging request, along with other charging information, and then transmits the offline charging request to offline charging system 116.

Assume at some point that a user of IMS device 140 roams from a service area of home IMS network 110 to a service area of visited IMS network 120. When IMS device 140 enters the service area of visited IMS network 120, IMS device 140 registers with visited IMS network 120. To initiate handover of the session from home IMS network 110 to visited IMS network 120, IMS device 140 transmits a session initiation message (e.g., SIP INVITE) to P-CSCF 122 in visited IMS network 120. P-CSCF 122 forwards the session initiation message to S-CSCF 112 in home IMS network 110. S-CSCF 112 receives the session initiation message, and communicates with handover application server 114 to hand over the session to visited IMS network 120. Because of the functionality of handover application server 114, the session continues uninterrupted over a new dialog of visited IMS network 120.

At initiation of the new dialog, a network element in visited IMS network 120 will assign a new ICID to the session. For example, P-CSCF 122 may assign the new ICID for the session. After the handover, if the network elements in home IMS network 110 generate offline charging requests as described above, some of the network elements will generate offline charging requests that include the original ICID and some of the network elements will generate offline charging requests that include the new ICID depending on which dialog the network element is relating to. This causes problems as the CDRs generated from these offline charging requests cannot be aggregated or correlated within offline charging system 116 as they have different ICIDs.

To overcome this in the embodiments described below, a roaming charging identifier (RCID) is assigned for the session. An RCID comprises any number, code, string, etc, that is assigned to a session in the event that the session is handed over between different operator networks. The RCID is global for the session and is not associated with any particular dialog of the session. A dialog is a SIP sub-session. Because handover application server 114 is a B2BUA, multiple SIP message flows are used for a session. Each SIP message flow may thus represent a dialog. The SIP message flows over home IMS network 110 are assigned one ICID while SIP message flows over visited IMS network 120 are assigned another ICID. Thus, the ICIDs may be different for different dialogs of the session. The RCID is assigned in addition to the ICIDs to be global among the dialogs of the session.

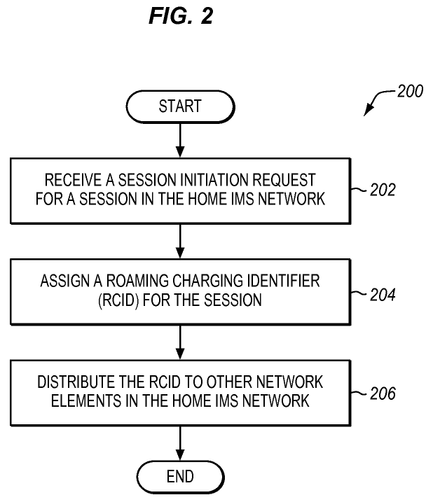

The RCID may be assigned in a desired network element of home IMS network 110, such as handover application server 114, and distributed to the other network elements. One embodiment for assigning the RCID is illustrated in FIG. 2.

FIG. 2 is a flow chart illustrating a method 200 of assigning an RCID for the handover session in an exemplary embodiment. The steps of method 200 will be described with reference to communication network 100 in FIG. 1, but those skilled in the art will appreciate that method 200 may be performed in other networks and systems. Also, the steps of the flow charts described herein are not all inclusive and may include other steps not shown, and the steps may be performed in an alternative order.

In this embodiment, the RCID is assigned in handover application server 114. To do so, handover application server 114 receives a session initiation request (i.e., SIP INVITE) for the session from S-CSCF 112 in step 202. S-CSCF 112 sends the session initiation request to handover application server 114 to provide seamless handover if IMS device 140 roams into another operator network. In step 204, handover application server 114 assigns the RCID for the session. In step 206, handover application server 114 distributes the RCID to other network elements in home IMS network 110. For example, handover application server 114 may reply to a first session initiation request from S-CSCF 112 with a second session initiation request (handover application server 114 is a B2BUA). Handover application server 114 inserts the RCID in the second session initiation request so that S-CSCF 112 is notified of the RCID. S-CSCF 112 may then process the second session initiation request to identify the RCID, and store the RCID for offline charging. Other network elements may operate in a similar manner to store the RCID for offline charging. Those skilled in the art will appreciate that network elements other than handover application server 114 may operate in a similar manner to assign the RCID.

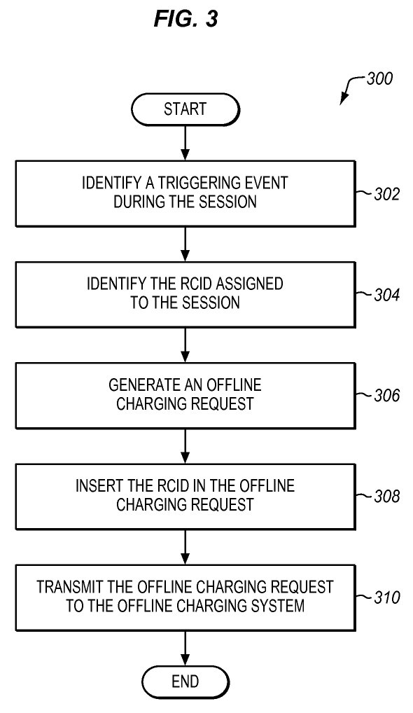

Now that the network elements in home IMS network 110 have received and stored the RCID, the network elements use the RCID for offline charging. FIG. 3 is a flow chart illustrating a method 300 of sending offline charging requests for a handover session to an offline charging system in an exemplary embodiment. The steps of method 300 will be described with reference to communication network 100 in FIG. 1, but those skilled in the art will appreciate that method 300 may be performed in other networks and systems.

In step 302, a network element in home IMS network 110 identifies a triggering event for charging during the session, such as based on a Charging Trigger Function (CTF). For example, a CTF in S-CSCF 112 or handover application server 114 may identify a triggering event for offline charging. In step 304, the network element identifies the RCID assigned to the session. In steps 306 and 308, the network element generates an offline charging request for the session, and inserts the RCID in the offline charging request. To insert the RCID in the offline charging request, a new parameter may be designated for the RCID. For example, a new AVP in a Diameter ACR message may be designated for the RCID. The network element may also insert one or more ICID's in the offline charging request depending on how many ICIDs are known to the network element.

In step 310, the network element transmits the offline charging request to offline charging system 116. Steps 302-310 may be repeated any number of times as the network element identifies a triggering event. For example, S-CSCF 112 may generate an ACR[start], multiple ACR[interims], and an ACR[stop] in a typical session. Also, multiple network elements in home IMS network 110 perform steps 302-310 in response to serving the session. Thus, multiple offline charging requests are sent to offline charging system 116 based on method 300. These offline charging requests are received in charging data function 118.

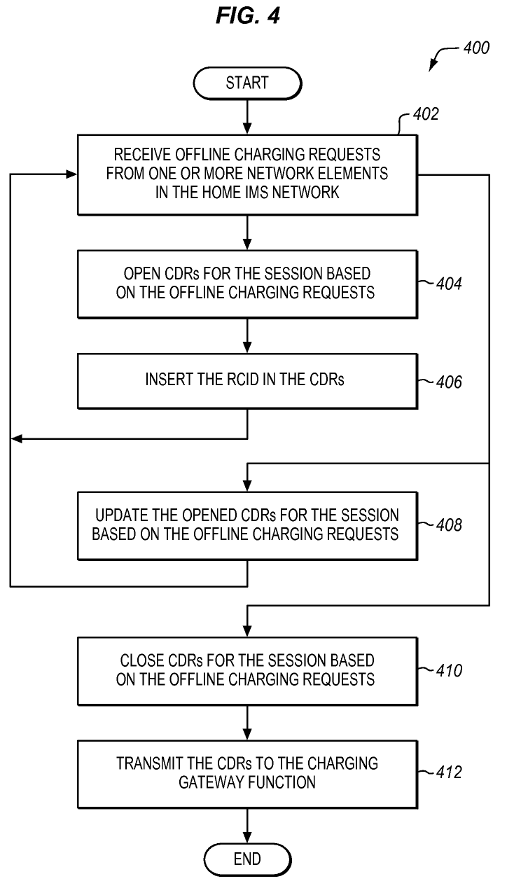

FIG. 4 is a flow chart illustrating a method 400 of processing the offline charging requests in charging data function 118 to generate CDRs in an exemplary embodiment. The steps of method 400 will be described with reference to communication network 100 in FIG. 1, but those skilled in the art will appreciate that method 400 may be performed in other networks and systems.

In step 402, charging data function 118 within offline charging system 116 receives the offline charging requests from one or more network elements in home IMS network 110 (i.e., P-CSCF 111, S-CSCF 112, or handover application server 114). In step 404, charging data function 118 opens or generates charging data records (CDRs) for the session based on the offline charging requests. For instance, charging data function 118 may receive a “start” offline charging request, such as an ACR[start], which causes charging data function 118 to open a CDR associated with the “start” request. Each of the offline charging requests includes the RCID, so charging data function 118 inserts the RCID in the CDRs in step 406. To insert the RCID, a new field may be designated in the CDR for the RCID. Thus, charging data function 118 inserts the RCID in the new CDR field. The offline charging requests also typically include one or more ICIDs. Charging data function 118 may also insert the ICID in the CDRs along with the RCID.

Based on further offline charging requests received in step 402, charging data function 118 updates the opened CDRs for the session in step 408. For instance, charging data function 118 may receive an “interim” offline charging request, such as an ACR[interim], which causes charging data function 118 to update the CDR associated with the “interim” request.

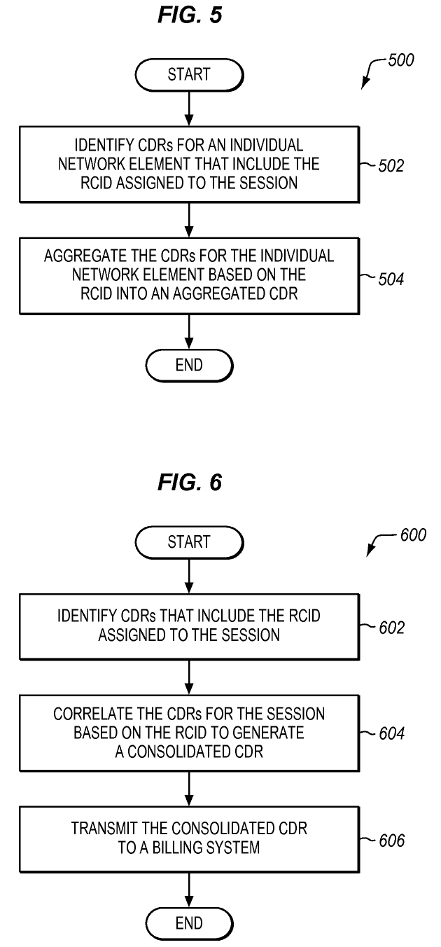

Based on further offline charging requests received in step 402, charging data function 118 closes each of the CDRs for the session in step 410. For instance, charging data function 118 may receive a “stop” offline charging request, such as an ACR[stop], which causes charging data function 118 to close the CDR associated with the “stop” request. After closing the CDRs, charging data function 118 transmits the CDRs to charging gateway function 119 in step 412. Charging gateway function 119 provides the function of aggregating CDRs per network element, and correlating CDRs for all network elements when the session is terminated. Because the CDRs each include the RCID, charging gateway function 119 is able to effectively aggregate and correlate the CDRs as described in FIG. 5.

FIG. 5 is a flow chart illustrating a method 500 of aggregating CDRs in charging gateway function 119 in an exemplary embodiment. The steps of method 500 will be described with reference to communication network 100 in FIG. 1, but those skilled in the art will appreciate that method 500 may be performed in other networks and systems.

In step 502, charging gateway function 119 identifies CDRs generated for an individual network element that include the RCID assigned to the session. For example, charging data function 118 will generate multiple CDRs for S-CSCF 112 in a typical session. As described in FIG. 4, the CDRs generated for S-CSCF 112 will each include the RCID that is assigned to the session. In step 504, charging gateway function 119 aggregates the CDRs for the individual network element based on the RCID into an aggregated CDR that also includes the RCID. This is advantageous in a handover scenario as a network element may generate CDRs that have multiple or different ICIDs. Thus, charging gateway function 119 is not able to aggregate the CDRs for an individual network element that have different ICIDs. With each CDR for an individual network element having the RCID, charging gateway function 119 is easily able to aggregate the CDRs for the network element.

After aggregating CDRs for one or more individual network elements, charging gateway function 119 correlates the CDRs. FIG. 6 is a flow chart illustrating a method 600 of correlating CDRs in charging gateway function 119 in an exemplary embodiment. The steps of method 600 will be described with reference to communication network 100 in FIG. 1, but those skilled in the art will appreciate that method 600 may be performed in other networks and systems.

In step 602, charging gateway function 119 identifies CDRs (aggregated or not) that include the RCID assigned to the session. In step 604, charging gateway function 119 correlates the CDRs for the session based on the RCID to generate a consolidated CDR for the session. Correlating the CDRs means forming some type of association between the CDRs so that they may be processed in billing system 130 to provide billing for the session. In step 606, charging gateway function 119 transmits the consolidated CDR to billing system 130. Billing system 130 may then process the consolidated CDR to generate a bill for the session. The consolidated CDR includes information for the entire session that was handed over from home IMS network 110 to visited IMS network 120. Thus, billing system 130 can advantageously bill for a single session even though the session was handed over to a different operator network.

If another handover occurs from visited IMS network 120 back to home IMS network 110 or to another operator network which is not shown in FIG. 1, then a similar process is performed to include the RCID in each CDR generated for the session. Thus, charging system 116 will then be able to aggregate and correlate the CDRs based on the RCID so that the entire session is charged as a single session no matter how many handovers occur during the session.

### EXAMPLE

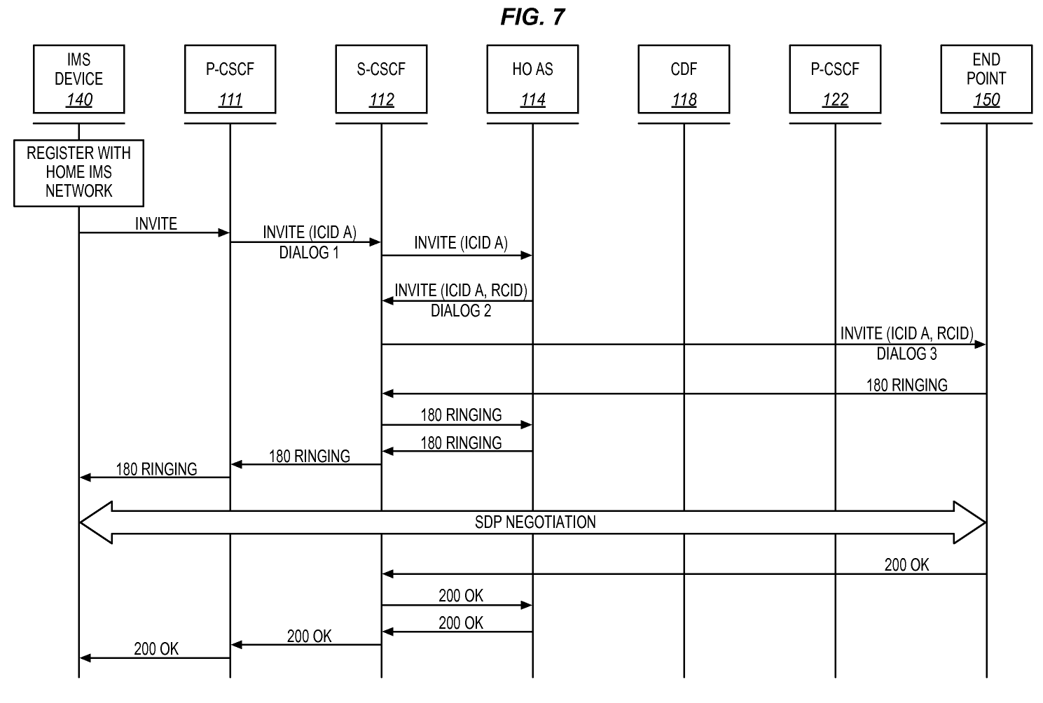

FIGS. 7-15 illustrate an example of offline charging for a session that is seamlessly handed over from home IMS network 110 to visited IMS network 120 as shown in FIG. 1. FIGS. 7-12 are message diagrams illustrating a session handed over between different operator networks in an exemplary embodiment. The message diagram illustrates SIP and Diameter messaging used within communication network 100, although other protocols may be used in other embodiments.

To start, IMS device 140 registers with home IMS network 110. To initiate the session in FIG. 7, IMS device 140 generates a SIP INVITE and transmits the SIP INVITE to P-CSCF 111 in home IMS network 110. P-CSCF 111 assigns an ICID for the session (ICID A), and inserts the ICID in the P-Charging-Vector of the SIP INVITE. P-CSCF 111 then forwards the SIP INVITE to S-CSCF 112 (dialog 1). Responsive to receiving the SIP INVITE, S-CSCF 112 processes initial filter criteria (iFC) for IMS device 140, which indicates that IMS device 140 is allowed handover between different operator networks. The iFC for IMS device 140 also includes an address for handover application server 114. Thus, S-CSCF 112 includes handover application server 114 (HO AS) in the session by transmitting the SIP INVITE to handover application server 114. In response to the SIP INVITE, handover application server 114 assigns a roaming charging identifier (RCID) for the session. Handover application server 114 is a back-to-back user agent (B2BUA) in this embodiment (as is S-CSCF 112), so handover application server 114 sets up another leg for the call. To do so, handover application server 114 transmits a SIP INVITE (dialog 2) back to S-CSCF 112 with ICID A and the RCID. S-CSCF 112 processes the SIP INVITE to identify the RCID assigned by handover application server 114, and stores the RCID for offline charging. S-CSCF 112 then transmits the SIP INVITE to end point 150. End point 150 responds to IMS device 140 with a SIP 180 ringing, and IMS device 140 and end point 150 begin SDP negotiation. When SDP negotiation has finished, end point 150 transmits a SIP 200 OK to S-CSCF 112, which forwards the SIP 200 OK back to IMS device 140 through handover application server 114 and P-CSCF 111.

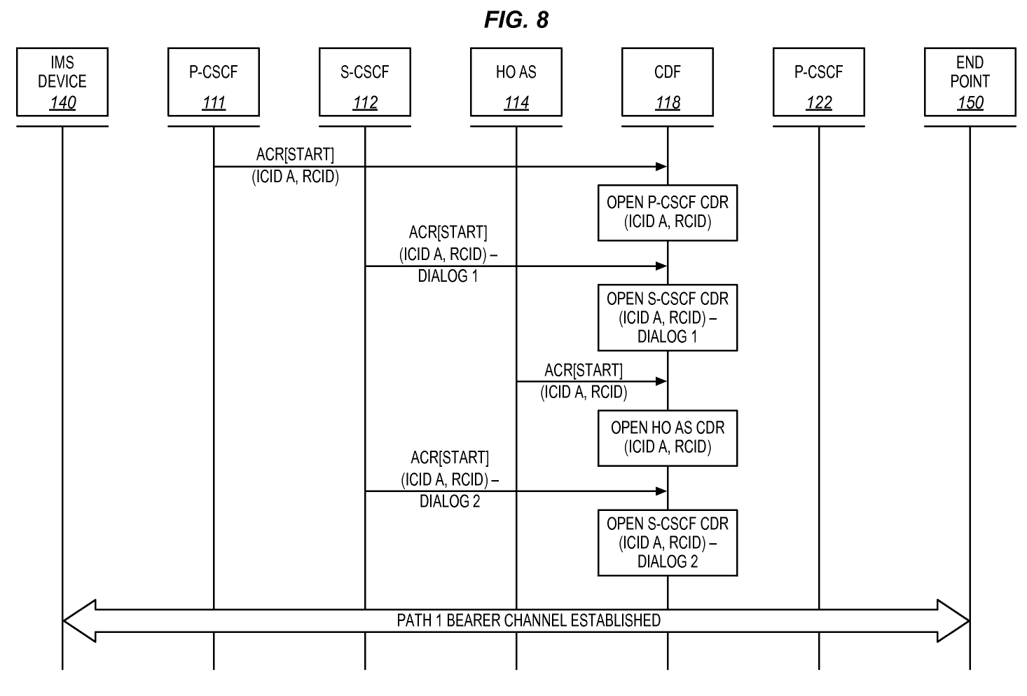

The SIP 200 OK is a trigger for the CTF in the network elements. In FIG. 8, P-CSCF 111 generates a Diameter ACR[start] in response to the SIP 200 OK, inserts ICID A and the RCID in the ACR[start], and transmits the ACR[start] to charging data function (CDF) 118. Responsive to the ACR[start], charging data function 118 opens a CDR for P-CSCF 111 and inserts ICID A and the RCID into the P-CSCF CDR.

Also in response to the SIP 200 OK, S-CSCF 112 generates a Diameter ACR[start], inserts the ICID A and the RCID in the ACR[start], and transmits the ACR[start] to charging data function 118. This ACR[start] is for the dialog from the side of IMS device 140, also referred to as dialog 1. Responsive to the ACR[start], charging data function 118 opens a CDR for S-CSCF 112 and inserts ICID A and the RCID into the S-CSCF CDR for dialog 1.

Similarly, handover application server 114 generates a Diameter ACR[start], inserts the ICID A and the RCID in the ACR[start], and transmits the ACR[start] to charging data function 118. Responsive to the ACR[start], charging data function 118 opens a CDR for handover application server 114 and inserts ICID A and the RCID into the HO AS CDR.

Because S-CSCF 112 receives the SIP 200 OK back from handover application server 114 (handover application server 14 is B2BUA), S-CSCF 112 will generate another Diameter ACR for the second dialog. Thus, S-CSCF 112 generates a Diameter ACR[start], inserts ICID A in the ACR[start], and transmits the ACR[start] to charging data function 118. This ACR[start] is for the dialog from the side of handover application server 114, also referred to as dialog 2. Responsive to the ACR[start], charging data function 118 opens a CDR for S-CSCF 112 and inserts ICID A and the RCID into the S-CSCF CDR for dialog 2.

When the SIP 200 OK is routed to IMS device 140, a bearer channel is established for the session between IMS device 140 and end point 150 (referred to herein as path 1), which is typically a Realtime Transport Protocol (RTP) channel. IMS device 140 and end point 150 may then communicate during the session via voice, text, multimedia, etc.

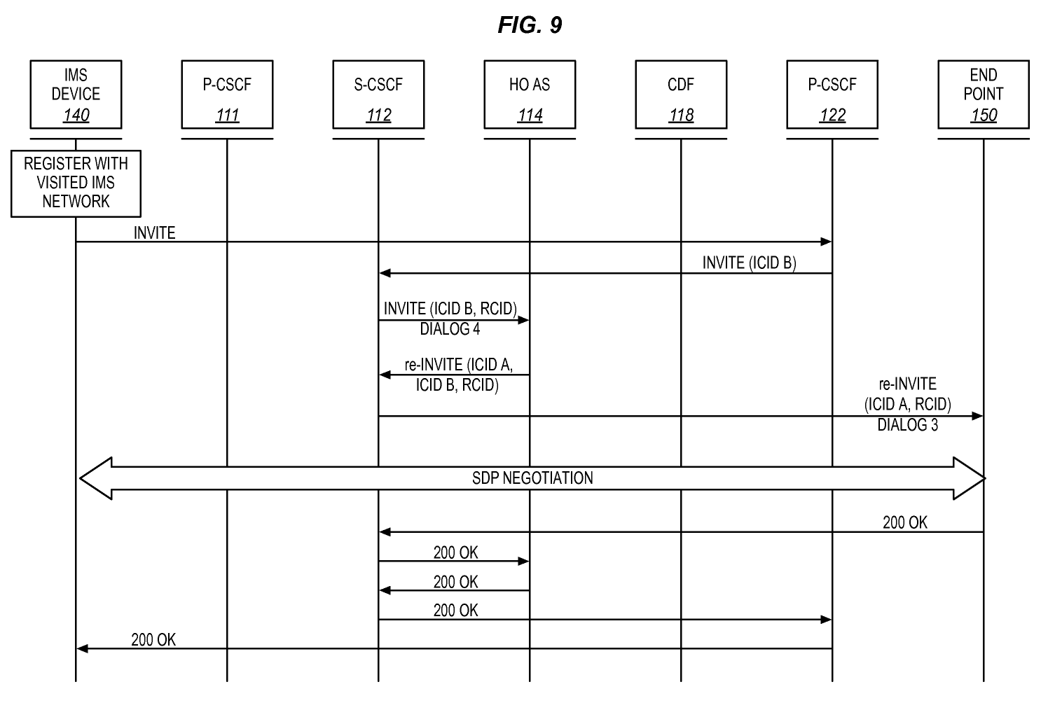

Assume that during the session, IMS device 140 moves to a service area of visited IMS network 120 and out of the service area of home IMS network 110. IMS device 140 is thus roaming in visited IMS network 120, and the session is to be handed over from home IMS network 110 to visited IMS network 120. To facilitate the hand over, IMS device 140 registers with visited IMS network 120 in FIG. 9, and then sends a SIP INVITE to P-CSCF 122 in visited IMS network 120. P-CSCF 122 assigns another ICID to the session, which is referred to as ICID B. P-CSCF 122 then transmits the SIP INVITE to S-CSCF 112 in home IMS network 110, as home IMS network 110 still provides call control. The SIP INVITE includes ICID B, which is inserted in the P-Charging-Vector of the SIP INVITE. Because IMS device 140 is now roaming, the dialog for the side of the IMS device 140 is now associated with ICID B instead of ICID A.

S-CSCF 112 transmits the SIP INVITE to handover application server 114 for dialog 4. Handover application server 114 transmits a SIP re-INVITE message back to S-CSCF 112. The SIP re-INVITE includes both ICID A and ICID B, and also includes the RCID. Because the SIP re-INVITE includes the RCID, S-CSCF 112 is able to associate dialog 4 with the RCID. S-CSCF 112 then transmits the SIP re-INVITE to end point 150 to maintain the existing call leg. At this point, IMS device 140 and end point 150 may perform SDP negotiation again. End point 150 responds with a SIP 200 OK to S-CSCF 112, which forwards the SIP 200 OK back to IMS device 140 through handover application server 114 and P-CSCF 122.

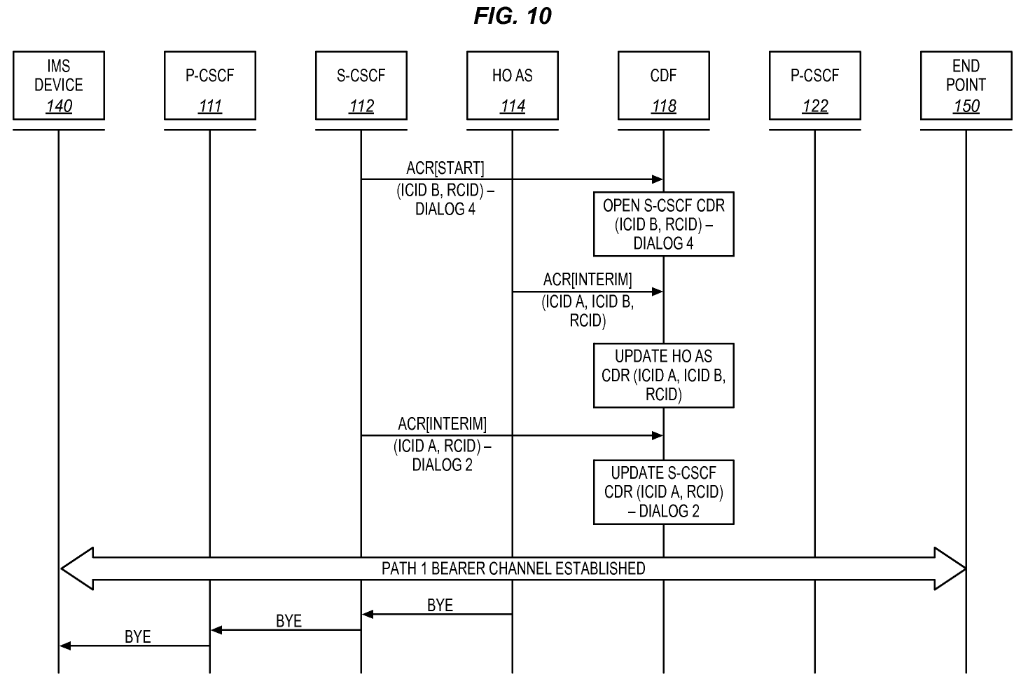

The SIP 200 OK is again a trigger for the CTF in the network elements. In FIG. 10, S-CSCF 112 generates a Diameter ACR[start] for the new dialog 4, inserts the ICID B and the RCID in the ACR[start], and transmits the ACR[start] to charging data function 118. This ACR[start] is for the dialog from the side of IMS device 140 over visited IMS network 120, which is dialog 4. Responsive to the ACR[start], charging data function 118 opens a CDR for S-CSCF 112 and inserts ICID B and the RCID into the S-CSCF CDR for dialog 4.

The SIP 200 OK is also a trigger for handover application server 114. Thus, handover application server 114 generates a Diameter ACR[interim], inserts ICID A, ICID B, and the RCID in the ACR[interim], and transmits the ACR[interim] to charging data function 118. Responsive to the ACR[interim], charging data function 118 updates the CDR for handover application server 114 with ICID B and new timestamps.

Because S-CSCF 112 receives the SIP 200 OK back from handover application server 114, S-CSCF 112 will generate another Diameter ACR. Thus, S-CSCF 112 generates a Diameter ACR[interim] for dialog 2, inserts ICID A and the RCID in the ACR[interim], and transmits the ACR[interim] to charging data function 118. Responsive to the ACR[interim], charging data function 118 updates the S-CSCF CDR for dialog 2.

When the SIP 200 OK is routed to IMS device 140, a bearer channel is established for the session between IMS device 140 and end point 150 (referred to herein as path 2), with the session now over visited IMS network 120. IMS device 140 and end point 150 may then communicate during the session via voice, text, multimedia, etc.

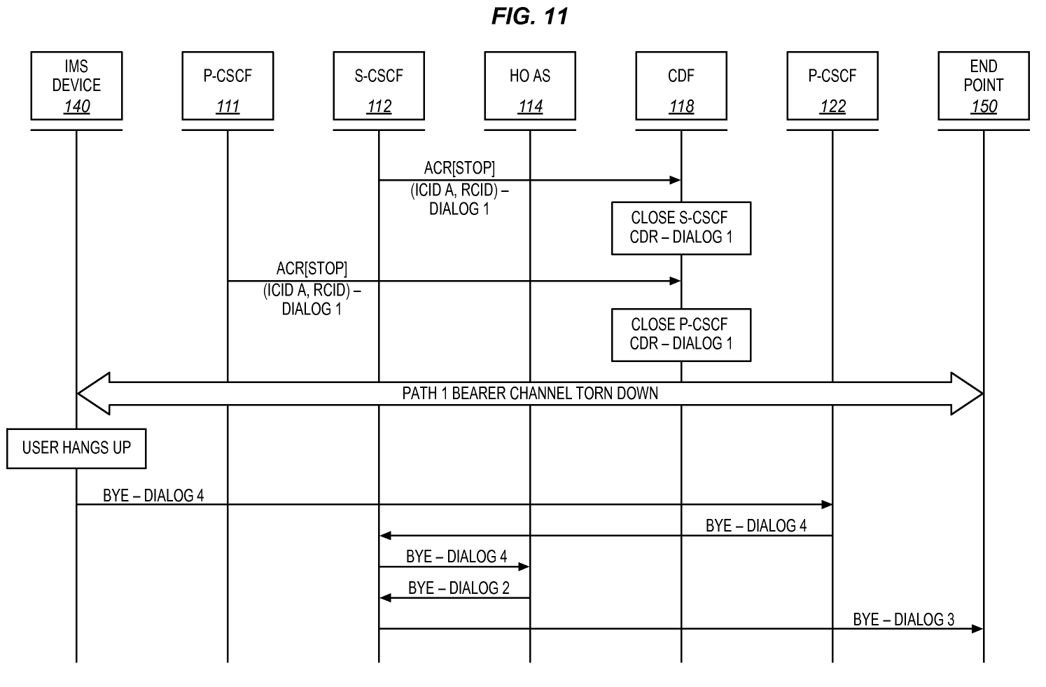

After handover is completed, handover application server 114 initiates the tear down the original dialog 1. Handover application server 114 thus generates a SIP BYE, and transmits the SIP BYE to IMS device 140 through S-CSCF 112 and P-CSCF 111. In response to the SIP BYE in FIG. 11, S-CSCF 112 generates a Diameter ACR[stop], inserts ICID A and the RCID in the ACR[stop], and transmits the ACR[stop] to charging data function 118. This ACR is for dialog 1. Responsive to the ACR[stop], charging data function 118 closes the S-CSCF CDR for dialog 1.

Also in response to the SIP BYE, P-CSCF 111 generates a Diameter ACR[stop], inserts ICID A and the RCID in the ACR[stop], and transmits the ACR[stop] to charging data function 118. Responsive to the ACR[stop], charging data function 118 closes the P-CSCF CDR. Path 1 is then torn down as the session between IMS device 140 and end point 150 is now over path 2.

Assume at some later point that IMS device 140 terminates the session, which is illustrated in FIG. 11. IMS device 140 terminates the session by sending a SIP BYE to P-CSCF 122. P-CSCF 122 transmits the SIP BYE to S-CSCF 112, which forwards the SIP BYE to end point 150 through handover application server 114.

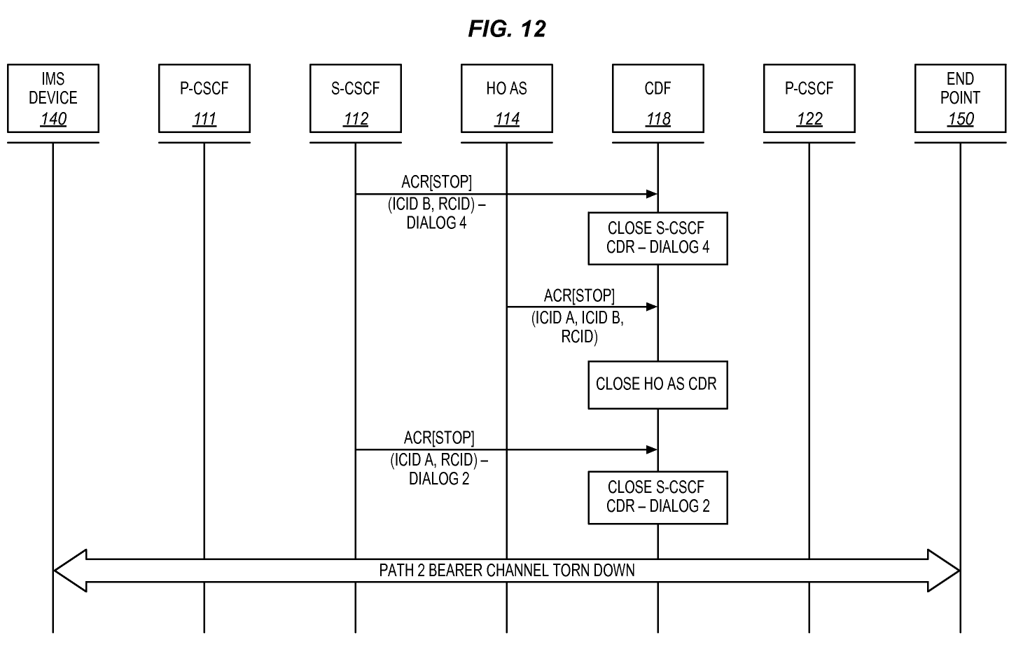

In response to the SIP BYE in FIG. 12, S-CSCF 112 generates a Diameter ACR[stop] for dialog 4, inserts the ICID B in the ACR[stop], and transmits the ACR[stop] to charging data function 118. Responsive to the ACR[stop], charging data function 118 closes the S-CSCF CDR for dialog 4, which includes ICID B and the RCID.

Also in response to the SIP BYE, handover application server 114 generates a Diameter ACR[stop], inserts ICID A, ICID B, and the RCID in the ACR[stop], and transmits the ACR[stop] to charging data function 118. Responsive to the ACR[stop], charging data function 118 closes the CDR for handover application server 114.

Because S-CSCF 112 receives the SIP BYE back from handover application server 114, S-CSCF 112 will generate another Diameter ACR. S-CSCF 112 generates a Diameter ACR[stop] for dialog 2, inserts the ICID A and the RCID in the ACR[stop], and transmits the ACR[stop] to charging data function 118. Responsive to the ACR[stop], charging data function 118 closes the S-CSCF CDR for dialog 2, which includes ICID A and the RCID. Additional SIP messages may then be exchanged to tear down the path 2 and end the session.

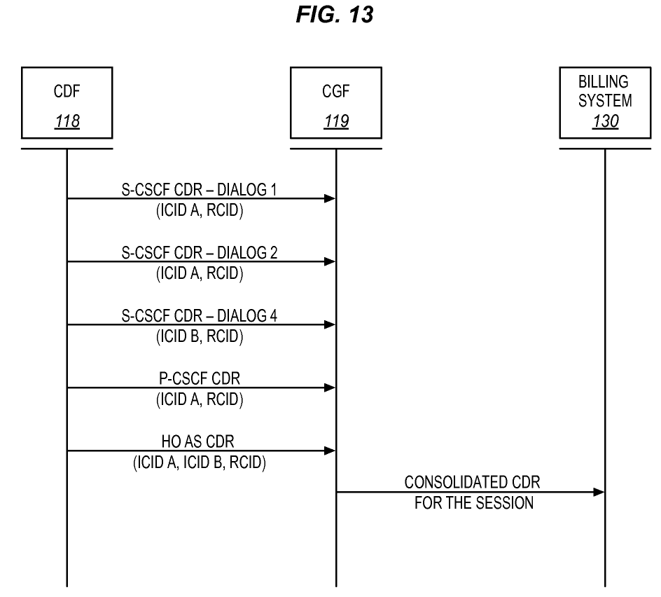

When the session is terminated, charging data function 118 will have generated multiple full CDRs for S-CSCF 112. Charging data function 118 generated a CDR for dialog 1 that includes ICID A and the RCID. Charging data function 118 also generated a CDR for dialog 2 that includes ICID A and the RCID. Even further, charging data function 118 generated a CDR for dialog 4 that includes ICID B and the RCID. These CDRs for S-CSCF 112 are sent to charging gateway function 119. FIG. 13 illustrates the CDRs sent from charging data function 118 to charging gateway function 119 in an exemplary embodiment.

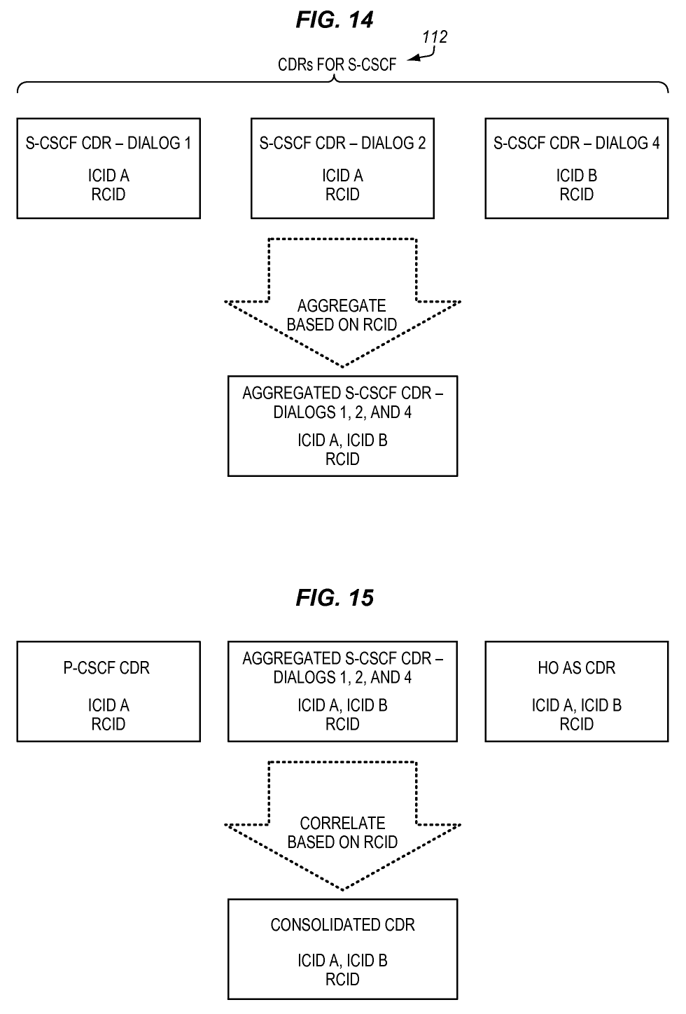

Charging gateway function 119 will first attempt to aggregate CDRs for individual network elements. In this example, S-CSCF 112 is a network element that has multiple CDRs. FIG. 14 illustrates aggregation of CDRs for S-CSCF 112 in an exemplary embodiment. As is shown in FIG. 14, the CDRs for dialogs 1 and 2 include ICID A, and the CDR for dialog 4 includes ICID B. Prior to defining the RCID for handover sessions, these CDRs could not be aggregated because the ICIDs are different for different dialogs. However, by including the RCID in the ACRs and in the CDRs, the CDRs for S-CSCF 112 can now be easily aggregated. Thus, charging gateway function 119 aggregates the CDRs for S-CSCF 112 based on the RCID to generate an aggregated CDR for S-CSCF 112.

Charging gateway function 119 then correlates the CDRs for the session from each network element that served the session. FIG. 15 illustrates correlation of CDRs for the session in an exemplary embodiment. Charging gateway function 119 has a CDR for P-CSCF 111, an aggregated CDR for S-CSCF 112, and a CDR for handover application server 114. Charging gateway function 119 then correlates these CDRs based on the RCID included in each CDR to generate a consolidated CDR for the session. Charging gateway function 119 then sends the consolidated CDR to billing system 130 (see also FIG. 13).

Because billing system 130 receives a single consolidated CDR for the session, billing system 130 will be able to rate and bill the session as a single session even though IMS device 140 roamed into another operator network. This is made possible because the RCID is assigned for the session, and distributed to network elements in home IMS network 110. The network elements include the RCID in offline charging requests (i.e., ACR), and the RCIDs are also included in the CDRs. Even though the session is handed over to another operator network, each offline charging request and CDR will include the RCID. Thus, the CDRs can be aggregated and correlated into a single consolidated CDR that billing system 130 may process. Billing system 130 bills the session as a single session based on the correlated CDR. This is especially advantageous if a stepped rating is used for IMS device 140, as the session will not be treated as a new session when handed over between home IMS network 110 and visited IMS network 120.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a charging data function operable to receive offline charging requests from at least one network element in a home IP Multimedia Subsystem (IMS) network for a session that is handed over between the home IMS network and a visited IMS network that are different operator networks, wherein the offline charging requests include a roaming charging identifier assigned to the session in the home IMS network that is global to a dialog of the session over the home IMS network and to a dialog of the session over the visited IMS network;
the charging data function further operable to open charging data records for the session based on the offline charging requests, and to insert the roaming charging identifier in the charging data records.

2. The system of claim 1 further comprising:
the charging data function further operable to receive additional offline charging requests from the at least one network element in the home IMS network for the session, and to close the charging data records for the session based on the additional offline charging requests; and
a charging gateway function operable to identify the charging data records for an individual network element that include the roaming charging identifier assigned to the session, and to aggregate the charging data records for the individual network element based on the roaming charging identifier into an aggregated charging data record.

3. The system of claim 2 further comprising:
the charging gateway function further operable to identify the charging data records that include the roaming charging identifier assigned to the session, to correlate the charging data records for the session based on the roaming charging identifier into a consolidated charging data record, and to transmit the consolidated charging data record to a billing system.

4. The system of claim 1 wherein:
the offline charging requests comprise Diameter charging requests; and
the charging data function is further operable to process the Diameter charging requests to identify the roaming charging identifier inserted in a new attribute value pair (AVP) in the Diameter charging requests.

5. The system of claim 1 wherein:
the roaming charging identifier is generated in the home IMS network by a handover application server that provides handover of the session between the home IMS network and the visited IMS network.

6. The system of claim 5 wherein the handover application server comprises a Voice Call Continuity (VCC) application server.

7. The system of claim 1 wherein:
the at least one network element in the home IMS network comprises a serving-call session control function (S-CSCF).

8. A method comprising:
receiving offline charging requests from at least one network element in a home IP Multimedia Subsystem (IMS) network for a session that is handed over between the home IMS network and a visited IMS network that are different operator networks,
wherein the offline charging requests include a roaming charging identifier assigned to the session in the home IMS network that is global to a dialog of the session over the home IMS network and to a dialog of the session over the visited IMS network;
opening charging data records for the session based on the offline charging requests; and
inserting the roaming charging identifier in the charging data records.

9. The method of claim 8 further comprising:
receiving additional offline charging requests from the at least one network element in the home IMS network for the session;
closing the charging data records for the session based on the additional offline charging requests;
identifying the charging data records for an individual network element that include the roaming charging identifier assigned to the session; and
aggregating the charging data records for the individual network element based on the roaming charging identifier into an aggregated charging data record.

10. The method of claim 9 further comprising:
identifying the charging data records that include the roaming charging identifier assigned to the session;
correlating the charging data records for the session based on the roaming charging identifier into a consolidated charging data record; and
transmitting the consolidated charging data record to a billing system.

11. The method of claim 8 wherein the offline charging requests comprise Diameter charging requests, and further comprising:
processing the Diameter charging requests to identify the roaming charging identifier inserted in a new attribute value pair (AVP) in the Diameter charging requests.

12. The method of claim 8 wherein:
the roaming charging identifier is generated in the home IMS network by a handover application server that provides handover of the session between the home IMS network and the visited IMS network.

13. The method of claim 12 wherein the handover application server comprises a Voice Call Continuity (VCC) application server.

14. The method of claim 8 wherein:
the at least one network element in the home IMS network comprises a serving-call session control function (S-CSCF).

15. A system comprising:
a network element operable to receive a session initiation request for a session that is allowed to be handed over between a home IP Multimedia Subsystem (IMS) network and a visited IMS network that are different operator networks, to assign a roaming charging identifier for the session that is global to a dialog of the session over the home IMS network and to a dialog of the session over the visited IMS network if the session is handed over between the home IMS network and the visited IMS network, and to distribute the roaming charging identifier to other network elements in the home IMS network for offline charging.

16. The system of claim 15 wherein the network element comprises a handover application server that is operable to provide a handover of the session between the home IMS network and the visited IMS network.

17. The system of claim 16 wherein the handover application server comprises a Voice Call Continuity (VCC) application server.

18. The system of claim 15 wherein the other network elements in the home IMS network include a serving-call session control function (S-CSCF).

19. The system of claim 15 further comprising:
the network element further operable to identify a triggering event during the session, to identify the roaming charging identifier assigned to the session, to generate an offline charging request, to insert the roaming charging identifier in the offline charging request, and to transmit the offline charging request to an offline charging system.

20. The system of claim 19 wherein:
the offline charging request comprises a Diameter charging request; and
the network element is further operable to insert the roaming charging identifier in a new attribute value pair (AVP) in the Diameter charging request.
